(19) United States
(12) Patent Application Publication
(10) Pub. No.: US 2025/0261214 A1
(43) Pub. Date: Aug. 14, 2025

(54) METHOD AND APPARATUS FOR DETERMINING RESOURCE BASED ON SIDELINK IN A WIRELESS COMMUNICATION SYSTEM

(71) Applicant: SAMSUNG ELECTRONICS CO., LTD., Suwon-si, Gyeonggi-do (KR)

(72) Inventors: Miao ZHOU, Beijing (CN); Min WU, Beijing (CN); Feifei SUN, Beijing (CN)

(21) Appl. No.: 18/860,479

(22) PCT Filed: Mar. 24, 2023
(86) PCT No.: PCT/KR2023/003915

§ 371 Date: Oct. 25, 2024

(30) Foreign Application Priority Data
Apr. 27, 2022 (CN) 202210458858.7
Aug. 10, 2022 (CN) 202210956585.9

(51) Int. Cl. H04W 72/25; H04W 72/0446

(52) U.S. Cl. CPC H04W 72/25; H04W 72/0446

(57) ABSTRACT

The disclosure relates to a 5G or 6G communication system for supporting a higher data transmission rate. The present disclosure provides a method performed by a first node in a communication system is provided. The method comprising: determining candidate resources on an unlicensed band; and selecting multiple resources from the candidate resources. This method combines advantages of a channel sensing used to avoid interference within system on the licensed band and a LBT technology used to avoid interference from other communication systems on the unlicensed band, so that a UE can select resources with better performance on the unlicensed band and minimize interference to other communication systems.

### TECHNICAL FIELD

Embodiments disclosed herein relate to a wireless communication system (or wireless networks) or a mobile communication system (or, mobile networks). More specifically, the disclosure relates to a method and an apparatus for determining resource based on Sidelink (SL) in the wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

According to developments of communication system, there are needs to enhance for determining resource based on sidelink in a wireless communication system.

### Solution to Problem

The present disclosure provides a method for resource selection based on interferences which may occur at any time on an unlicensed band. This method combines advantages of channel sensing used to avoid an interference within a system on an licensed band and a LBT technology used to avoid an interference from other communication systems on the unlicensed band, so that the UE can select resources with better performances on the unlicensed band and minimize interferences to other communication systems.

In an aspect of the embodiments of the present disclosure, a method performed by a first node in a communication system is provided, the method comprising: determining candidate resources on an unlicensed band; and selecting multiple resources from the candidate resources.

In one implementation, the method further comprises transmitting one or more sidelink data on the selected multiple resources, including at least one of: performing one transmission of one sidelink data on the selected multiple resources or a subset thereof; performing multiple transmissions of one sidelink data on the selected multiple resources or subsets thereof; and performing multiple transmissions of multiple sidelink data on the selected multiple resources or a subset thereof.

In one implementation, the selecting multiple resources from the candidate resources includes: selecting multiple resources being discrete or consecutive in time; and/or selecting multiple resources being consecutive in time.

In one implementation, the method further comprises: excluding the candidate resources conflicting with transmissions of other nodes based on the channel sensing; and selecting the multiple resources from the remaining candidate resources.

In one implementation, the selecting multiple resources being consecutive in time from the candidate resources includes determining the candidate resources with a length m time units within a resource selection window, m is an integer greater than 1, and includes at least one of: monitoring PBPS occasions with a length of m time units when using periodic-based partial sensing PBPS; determining a start and an end positions of a monitored CPS window based on the candidate resources with the length of m time units when using continuous partial sensing CPS; determining whether m time units in the candidate resources have been monitored to determine whether to exclude the candidate resources; determining whether the m time units in the candidate resources and/or future resources corresponding to the m time units in the candidate resources overlap with reserved resources indicated in a received sidelink control information SCI and/or future reserved resources indicated in the SCI to determine whether to exclude the candidate resources.

In one implementation, the determining whether the m time units in the candidate resources have been monitored to determine whether to exclude the candidate resources includes one of: excluding the candidate resource when any one of the m time units in which the candidate resource are located is not monitored; and excluding the candidate resource according to a number of the time units which are not be monitored among the m time units in which the candidate resource is located.

In one implementation, the determining whether the m time units in the candidate resources and/or future resources corresponding to the m time units in the candidate resources overlap with reserved resources indicated in a received sidelink control information SCI and/or future reserved resources indicated in the SCI to determine whether to exclude the candidate resources includes one of: excluding the candidate resource when any time unit of the m time units in which the candidate resources are located and/or its future corresponding resources overlap with the reserved resources and/or the future reserved resources indicated in the received SCI; and excluding the candidate resource according to the number of time units, among the m time units in which the candidate resources are located, that overlap the reserved resources and/or future reserved resources indicated in the received SCI, and/or according to the number of time units among the m time units whose future corresponding resources overlap the reserved resources and/or future reserved resources indicated in the received SCI.

In one implementation, the method further comprises: determining the value of m according to a channel condition.

In one implementation, the determining the value of m according to a channel condition includes at least one of: determining m according to at least one of a number of sidelink data transmitted, a number of sidelink data transmissions, and a number of transmission occasions corresponding to each sidelink data transmission; determining m according to a value of a channel busy rate CBR and/or a value of a channel occupation rate CR; and determining m according to the number of remaining resources after excluding candidate resources conflicting with the transmissions of other nodes based on the channel sensing.

In one implementation, the method further comprises at least one of: determining the resources being discrete or consecutive in time corresponding to the sidelink data according to parameters of each sidelink data in the multiple sidelink data; and determining the resources being discrete or consecutive in time corresponding to the multiple sidelink data according to the maximum or minimum value of the parameters of the multiple sidelink data.

In one implementation, the latest time of the candidate resources does not exceed the end position of a channel occupation time COT.

In one implementation, the selecting multiple resources from the candidate resources includes: excluding the candidate resource when physical sidelink feedback channel resources corresponding to the candidate resource is outside the channel occupancy time COT.

In one implementation, the method further comprises transmitting information on the selected multiple resources or subsets of the multiple resources to a second node, wherein the second node uses the multiple resources or subsets of the multiple resources to send sidelink data.

In one implementation, indicating the multiple resources or a subset of the multiple resources to the second node in an inter-UE coordination IUC information.

In one implementation, the method further comprises determining a resource selection window for selecting the multiple resources or the subsets of the multiple resources based on a time range for selecting resource provided by the second node.

In one implementation, the selected multiple resources include a first resource set and a second resource set, the first resource set includes resources for the first node, and the second resource set includes resources for the second node, and wherein: when the first node does not expect to receive the transmission from the second node, the first resource set and the second resource set overlap or do not overlap in the time domain; and/or when the first node expects to receive the transmission from the second node, the first resource set and the second resource set do not overlap in the time domain.

In one implementation, the multiple resources or subsets of the multiple resources are consecutive in the time domain.

In one implementation, if the selected multiple resources include resources being not in the current channel occupation time COT, the method further comprises at least one of: selecting multiple transmission occasions for each resource being not in the current COT, locations of the transmission occasions is predefined or preconfigured; calculating an offset of resources with skipping the time domain range where COT is not acquired, the offset represents a time domain offset between resources used for two transmissions; and if the COT is not obtained at the resource or listen before talk (LBT) detection fails, dropping transmission of the sidelink data on the source.

In one implementation, the selected resource is determined in the current listen before talk (LBT) band or other LBT bands.

In one implementation, indicating the selected resources in the sidelink control information SCI, including indicating the resources in the current LBT band and/or indicating the resources in other LBT bands by at least one of: using multiple independent domains to indicate the resources in the each LBT band respectively; using a specific domain to indicate the LBT band in which the each resource is located, and using the same domain to indicate the location of each resource in the LBT band; and using mapping to indicate the LBT band in which each resource is located, and explicitly indicating the location of the resource in the LBT band.

In one implementation, when the selected resources are in the multiple LBT bands in one time unit, the method further comprises at least one of: transmitting same sidelink data in the multiple LBT bands; transmitting different sidelink data in the multiple LBT bands; transmitting sidelink data in the LBT band detected by LBT in multiple LBT bands.

In another aspect of the embodiments of the present disclosure, there is provided a node device, comprising: a transceiver; and a controller coupled to the transceiver and configured to perform the method of any one of claims 1-15.

### Advantageous Effects of Invention

According to various embodiments of the disclosure, determining resource based on sidelink in a wireless communication system can be efficiently enhanced.

### BRIEF DESCRIPTION OF DRAWINGS

For a more complete understanding of this disclosure and its advantages, reference is now made to the following description, taken in conjunction with the accompanying drawings, in which:

FIG. 1 shows an example wireless network 100 according to various embodiments of the present disclosure;

FIG. 2A shows an example wireless transmission and reception path according to the present disclosure;

FIG. 2B shows an example wireless transmission and reception path according to the present disclosure;

FIG. 3A shows an example UE according to the present disclosure;

FIG. 3B shows an example gNB according to the present disclosure;

FIG. 4 is a flowchart showing a method according to an embodiment of the present disclosure; and

FIG. 5 is a block diagram showing an electronic device according to an embodiment of the present disclosure.

FIG. 6 illustrates a block diagram of a terminal (or a user equipment (UE), according to embodiments of the present disclosure; and

FIG. 7 illustrates a block diagram of a base station according to embodiments of the present disclosure.

### MODE FOR THE INVENTION

Before undertaking the DETAILED DESCRIPTION below, it may be advantageous to set forth definitions of certain words and phrases used throughout this patent document. The term “couple” and its derivatives refer to any direct or indirect communication between two or more elements, whether those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. Likewise, the term “set” means one or more. Accordingly, a set of items can be a single item or a collection of two or more items.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

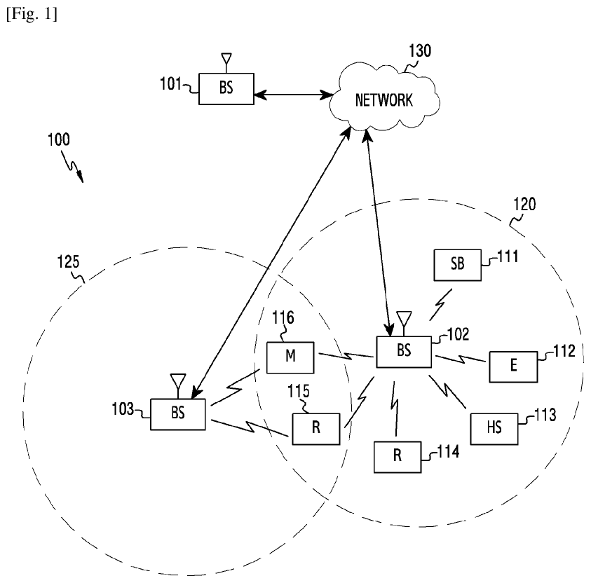

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

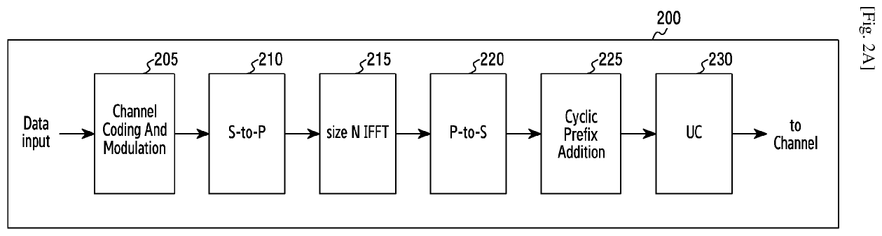

FIGS. 2A and 2B illustrate example wireless transmission and reception paths according to the present disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

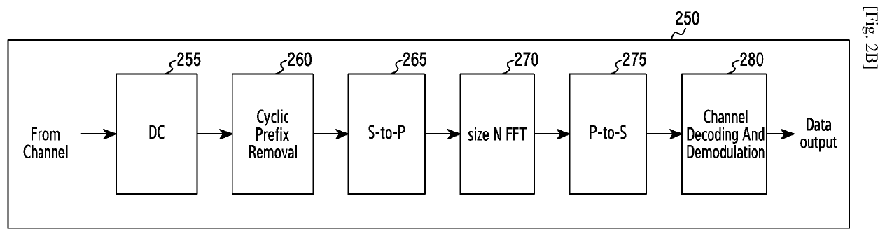

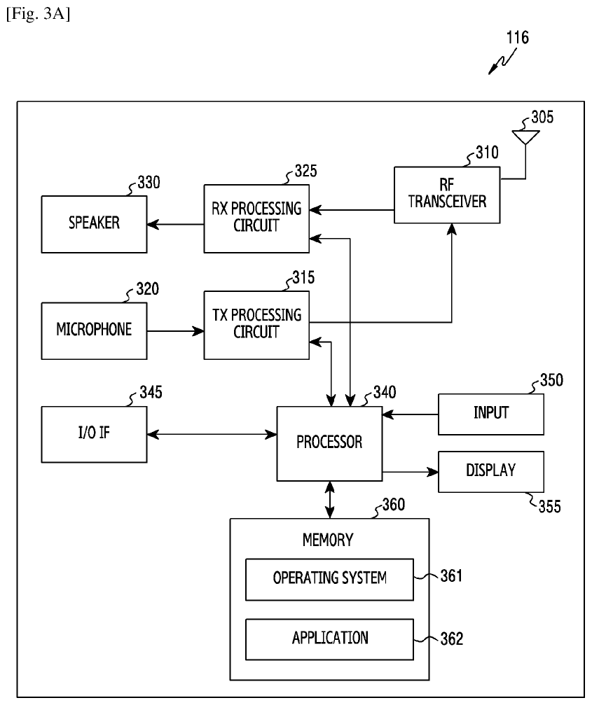

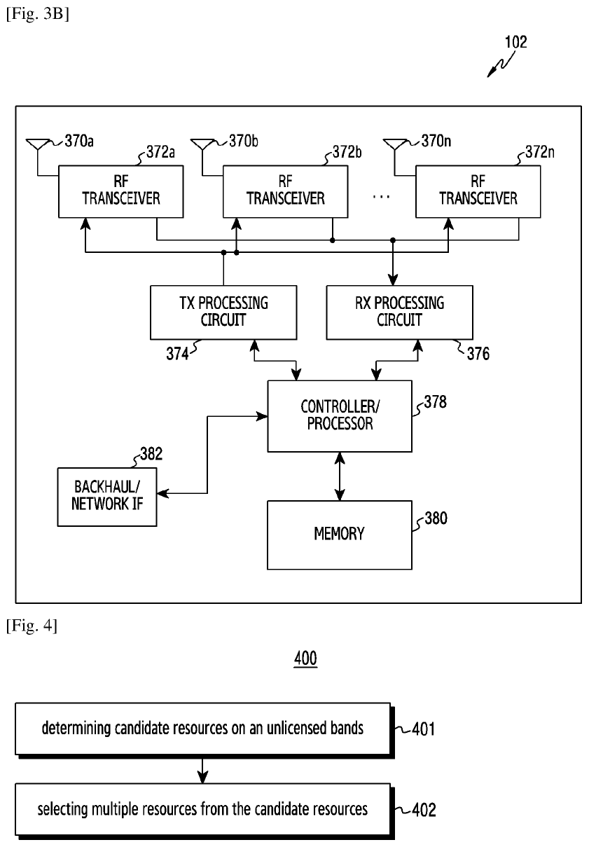

FIG. 3A illustrates an example UE 116 according to the present disclosure. The embodiment of UE 116 shown in FIG. 3A is for illustration only, and UEs 111-115 of FIG. 1 can have the same or similar configuration. However, a UE has various configurations, and FIG. 3A does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to the present disclosure. The embodiment of gNB 102 shown in FIG. 3B is for illustration only, and other gNBs of FIG. 1 can have the same or similar configuration. However, a gNB has various configurations, and FIG. 3B does not limit the scope of the present disclosure to any specific implementation of a gNB. It should be noted that gNB 101 and gNB 103 can include the same or similar structures as gNB 102.

As shown in FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

In Long Term Evolution (LTE) technology, sidelink communication includes two main types of mechanisms: direct communication from Device to Device (D2D) and Vehicle to Vehicle/Infrastructure/Pedestrian/Network (V2X) communication. V2X is designed on the basis of D2D technology and is superior to D2D in terms of data rate, delay, reliability, link capacity, etc. It is the most representative sidelink communication technology in LTE technology. In 5G system, sidelink communication currently mainly includes Vehicle to Vehicle/Infrastructure/Pedestrian/Network (V2X) communication.

As the evolution technology of LTE, the 5G NR system also includes the further evolution of sidelink communication. The NR V2X technology was developed in Version 16. As the evolution version of LTE V2X technology, the NR V2X has better performance in all aspects. In Version 17, the 5G NR system is expected to further expand the application scenarios of NR V2X to other broader application scenarios, such as commercial sidelink communication and public safety (PS) scenarios. In version 18, the evolution of sidelink communication includes the aspects for un-licensed band, FR2, carrier aggregation, co-channel coexistence with LTE, and so on. It also includes support for technologies in other fields such as positioning, SL technologies in high-frequency (FR2) and unlicensed bands, and SL technologies corresponding to specific applications such as positioning.

In the sidelink communication system of LTE and NR, the sidelink communication system is mainly designed based on the requirements of specific D2D and vehicle business scenarios, and the frequency bands used are mainly concentrated in specific licensed bands, such as ITS frequency bands dedicated to vehicle traffic. With the development of 5G technology, the business model of sidelink communication is increasing. Therefore, it is necessary to enhance the sidelink communication technology so that it can be applied in a wider range of application scenarios, such as XR, IIoT, RedCap, etc. For the service requirements of some future application scenarios, the transmission rate, delay and reliability that the current sidelink communication technology can achieve need to be further enhanced. A feasible method is to apply the sidelink communication to more frequency bands, such as unlicensed bands, to increase the transmission rate that the sidelink system can support and improve reliability by increasing the bandwidth, and to reduce the service transmission delay through high-frequency communication. However, the current sidelink communication system does not discuss the possibility of sidelink communication on the unlicensed band, nor does it introduce any enhancement mechanism for the unlicensed band.

In the embodiment of the present disclosure, the information configured by the base station, indicated by signaling, configured by high-level, and pre-configurated include a set of configuration information; also include multiple sets of configuration information, from which the UE selects a set of configuration information for use according to predefined condition; and also includes a set of configuration information including multiple subsets, from which UE selects a subset for use according to predefined condition.

In the embodiment of the present disclosure, lower than threshold value can also be replaced by lower than or equal to threshold, higher than (more than) threshold value can also be replaced by higher than or equal to threshold, lower than or equal to threshold value can also be replaced by lower, higher than or equal to threshold value can also be replaced by higher than; vice versa.

Some technical solutions provided in the embodiments of the present disclosure are specifically described based on the V2X system, but its application scenarios should not be limited to the V2X system in the sidelink communication, and can also be applied to other sidelink transmission systems. For example, the design based on V2X sub-channel in the following embodiments can also be used for D2D sub-channel or sub-channel for other sidelink transmission. The V2X resource pool in the following embodiment can also be replaced by the D2D resource pool in other sidelink transmission systems, such as D2D.

In the embodiment of the present disclosure, when the sidelink communication system is the V2X system, the terminal or UE may be a vehicle, an infrastructure, a pedestrian and other types of terminals or UEs.

The base station in this specification may also be replaced with other nodes, such as a sidelink node. A specific example is the infrastructure UE in the sidelink system. Any mechanism applicable to the base station in this embodiment can be similarly used in the scenario where the base station is replaced by other sidelink nodes, and the explanation will not be repeated.

The timeslot in this specification may also be replaced with time unit, candidate timeslot may also be replaced with candidate time unit, and candidate single timeslot resource may also be replaced with candidate single time unit resource. The time unit includes a specific length of time, such as several consecutive symbols.

The timeslot in this specification may be a subframe or timeslot in the physical sense, or a subframe or timeslot in the logical sense. Specifically, the subframe or timeslot in the logical sense is the subframe or timeslot corresponding to the resource pool of the sidelink communication. For example, in the V2X system, the resource pool is defined by a repeated bitmap, which maps to a specific set of timeslots, which can be all timeslots or all other timeslots except for some specific timeslots (such as the timeslots of the transmission MIB (Master Information Block)/SIB (System Information Block)). The timeslot indicated as “1” in the bitmap can be used for V2X transmission and belongs to the timeslot corresponding to the V2X resource pool; the timeslot indicated as “0” is not available for V2X transmission and does not belong to the timeslot corresponding to the V2X resource pool.

The following describes the difference between subframe or timeslot in the physical sense and the logical sense through a typical application scenario: when calculating the time gap between two specific channels/messages (such as PSSCH carrying sidelink data and PSFCH carrying corresponding feedback information), it is assumed that the gap is N timeslots. If the subframe or timeslot in the physical sense is calculated, the N timeslots correspond to the absolute time length of N*x milliseconds in the time domain, and x is the time length of the physical timeslot (subframe) under the numerology of the scene, in milliseconds. Otherwise, if the subframe or timeslot in the logical sense is calculated, take the sidelink resource pool defined by the bitmap as an example, the gap of the N timeslots corresponds to the N timeslots indicated as “1” in the bitmap, and the absolute time length of the gap varies with the specific configuration of the sidelink communication resource pool, and there is no fixed value.

Further, the timeslot in this specification may be a complete timeslot or a number of symbols corresponding to the sidelink communication in one timeslot. For example, when the sidelink communication is configured to be performed on the X1˜X2 symbols in each timeslot, the timeslots in the following embodiment is the X1˜X2 symbols in the timeslot in this scenario; alternatively, when the sidelink communication is configured for mini-slot transmission, the timeslots in the following embodiments are defined or configured in the sidelink system, not the timeslot in the NR system; alternatively, when the sidelink communication is configured for symbol level transmission, the timeslots in the following embodiments can be replaced with symbols, or can be replaced with N symbols as time domain granularity of symbol level transmission.

In order to make the purpose, technical solution and advantages of the present disclosure clearer, the following will be further described in detail in combination with the drawings.

The text and drawings are provided only as examples to help readers understand the present disclosure. They are not intended and should not be construed as limiting the scope of the present disclosure in any way. Although some embodiments and examples have been provided, based on the content disclosed herein, it will be apparent to those skilled in the art that the embodiments and examples shown can be changed without departing from the scope of the present disclosure.

In the LTE sidelink communication system and the NR V2X system of Version 16, the frequency domain resources used for the sidelink communication are usually located in the licensed band. Generally, it is assumed that there is basically no interference from other external communication systems (such as WiFi, Bluetooth, etc.) in this frequency band. However, for the sidelink communication system operating in the unlicensed band, the interference of other communication systems to the sidelink communication needs to be considered on the unauthorized carrier, and the interference of sidelink communication to other communication systems needs to be limited according to regulations.

In the NR unlicensed (NR-U) system of Versions 15 and 16, listen before talk (LBT) is utilized as one of the typical technologies in the unlicensed band. In this technology, a special frame structure is defined for the NR communication system on the unlicensed band. The frame structure contains several gaps for LBT. The UE and the base station need to perform LBT before uplink and downlink transmission, and can only send various wireless signals/channels normally after the LBT passes. In this embodiment, a method of using LBT technology for the sidelink communication system is provided.

In the communication system on the unlicensed band, a channel occupancy (CO) refers to the transmission on the corresponding channel after the base station/UE performs the channel access. A Channel occupancy time (COT) refers to the total transmission time on the corresponding channel after the base station/UE and the base station/UE sharing the channel occupy perform the channel access. The base station and/or sidelink UE each can initialize a COT and share the COT with other base stations and/or sidelink UEs. After initializing a COT or obtaining a COT shared by the base station/other nodes, the UE needs to determine the structure and location of the sidelink resource in the COT. In this embodiment, the specific method for determining the structure and location of the sidelink resource in the COT is described.

In NR-Unlicensed (NR-U) technology, the structure of the uplink/downlink resources in the COT can be reflected through the uplink/downlink burst, where the uplink/downlink burst is a set of transmission from the base station or UE, and there is no gap exceeding a specific length between them. Similar to the definition of uplink/downlink burst in the prior art, the structure of the sidelink resource in the COT can also be reflected by the sidelink burst, where the sidelink burst is a set of transmission from the UE, and there is no gap exceeding a specific length (such as 16 us) between them. Alternatively, only transmissions from the same UE are included in one burst; or, one burst may include transmissions from the same or different UEs. Alternatively, only one or more specific signals/channels are included in one burst. For example, one burst only includes the Physical Sidelink Control Channel (PSCCH) and/or Physical Sidelink Shared Channel (PSSCH), and the other burst only includes the Physical Sidelink Feedback Channel (PSFCH), or one burst can include PSCCH, PSSCH and PSFCH. Alternatively similar to the discovery burst in the prior art, the sidelink synchronization signal, the sidelink synchronization channel, and the sidelink reference signal (which can be a specific type of reference signal/a reference signal meeting specific conditions) correspond to the sidelink discovery burst rather than the general sidelink burst.

In the sidelink communication technology, in view of resource allocation, the 5G sidelink communication system includes two modes: a resource allocation mode based on base station scheduling and a resource allocation mode autonomously selected by UE. In 5G V2X system, the resource allocation mode based on base station scheduling and the resource allocation mode autonomously selected by UE are called Mode 1 and Mode 2 respectively. For resource allocation Mode 2, the sidelink UE can autonomously select resources by keeping the monitoring and caching of the sidelink resource pool, and determining a channel sensing time window and a resource selection time window according to the expected time range of sending sidelink transmission before the sidelink transmission that needs to be sent, sensing channel within the channel sensing time window, the sidelink resources that have been reserved by other sidelink UEs are excluded in the resource selection time window according to the results of channel sensing, and randomly selecting the resources for the sidelink transmission are from the sidelink resources that are not excluded in the resource selection time window. When the mechanism operates on the unlicensed band, due to the characteristics of the unlicensed band itself, the mechanism also needs to be modified accordingly to adapt to the uncertainty caused by the COT sharing based channel preemption mechanism and LBT on the unlicensed band, and make the operation of the sidelink communication on the unlicensed band not violate the restrictions of laws and regulations.

FIG. 4 shows a flowchart of a method 400 according to an embodiment of the present disclosure. The method 400 may be executed by the first node. In the present disclosure, the first node may be the first UE, and the second node may be the second UE.

In method 400, in step 401, candidate resources are determined on unlicensed band.

In step 402, multiple resources are selected from the candidate resources.

In one implementation, the method 400 also includes transmitting one or more sidelink data on the selected multiple resources.

In the present disclosure, the sidelink data may include PSCCH, PSSCH and PSFCH. The following description will take PSSCH as an example, but PSSCH can also be replaced by PSFCH or PSCCH, or at least one of PSSCH, PSFCH and PSCCH.

In this specification, the first UE selects sidelink resource on an unlicensed band based on channel sensing, which may be used for transmission of the first UE or for transmission of the second UE.

In the sidelink communication system on the licensed band, during one channel determination process, the upper layer of the first UE may provide the physical layer with relevant parameters of a transmission block (TB), and the physical layer of the first UE selects one or more resources to transmit the TB based on the relevant parameters.

In the sidelink communication system on the unlicensed band, an optional method is that in one channel determination process, the upper layer of the first UE may provide the physical layer with the relevant parameters of one or more TB, and the physical layer of the first UE selects multiple resources to transmit the one or more TB based on the relevant parameters. Further, the multiple resources or a subset thereof may be used for at least one of the following.

It is used to transmit one PSSCH. Specifically, it is used for one transmission of the PSSCH (that is, it is not used for retransmission). Alternatively, the multiple resources are used as the transmission occasion for the PSSCH. The first UE attempts to transmit the PSSCH on each transmission occasion, such as performing LBT on or before each transmission occasion. If the LBT passes, the PSSCH can be sent; otherwise, if the LBT fails, the PSSCH cannot be sent. After the first UE successfully sent the PSSCH on one of the transmission occasions, if there are remaining resources, the remaining resources will not be used (that is, the UE releases the remaining transmission occasions), and/or the remaining resources can be used for other retransmissions of the PSSCH, and/or the remaining resources can be used for the first transmission and/or retransmission of the PSSCH corresponding to other TBs. Alternatively, one PSSCH is mapped to the multiple resources or subset thereof.

It is used for multiple transmissions of one PSSCH. Alternatively, the multiple resources are used as the transmission occasions of the PSSCH. The first UE attempts to send the PSSCH on each or every x transmission occasions, such as performing LBT on or before each transmission occasion. If the LBT passes, the PSSCH can be sent. Otherwise, if the LBT fails, one transmission of the PSSCH will be abandoned, or continue to attempt to send the PSSCH on other (alternatively, up to x−1) transmission occasions. Alternatively, when the first UE is configured to transmit the PSSCH N times, N resources may be selected accordingly; or when the UE is configured to transmit the PSSCH N times, N*x resources may be selected, where N, x are positive integers, and x is the number of transmission occasions corresponding to each transmission of the PSSCH. Alternatively, the first UE attempts to send the PSSCH on every x resources, specifically, the PSSCH is mapped to the x resources. For example, the UE determines that four resources are used for two transmissions of one PSSCH. The first transmission is mapped to the first two resources, and the second transmission is mapped to the last two resources. The method of using multiple resources for multiple transmissions of one PSSCH can also be interpreted as the repeat or blind re-transmission of PSSCH.

It is used for multiple transmissions of multiple PSSCHs. Each PSSCH corresponds to one or more transmissions, and the transmission times of different PSSCHs can be the same or different. Alternatively, when the number of PSSCH transmission is configured to N, the first UE selects N or N*X resources for it. Alternatively, the multiple resources are used as transmission occasions for the multiple PSSCH. The first UE attempts to send the PSSCH on one or more transmission occasions corresponding to each PSSCH, such as performing LBT on or before each transmission occasion. If the LBT passes, the PSSCH can be sent. Otherwise, if the LBT fails, abandoning one transmission of the PSSCH, or continuing to attempt to send the PSSCH on other transmission occasions corresponding to the PSSCH. Alternatively, the number of resources selected by the first UE is the sum of the number of transmission times or the number of transmission occasions corresponding to each PSSCH. Alternatively, the multiple resources are used as the mapping of the multiple PSSCHs. For example, the UE determines that four resources are used for each transmission of two PSSCHs. The UE maps the first PSSCH to the first two resources and the second PSSCH to the last two resources.

In the above method, further, the multiple resources may be consecutive or nonconsecutive in the time domain.

The advantage of selecting consecutive multiple resources is that UE can maintain the occupation of the channel by sending some noise signals (also called dummy signals) in the gap between transmissions (such as guard symbols). In this case, only LBT needs to be performed on the first resource in the consecutive multiple resources, and PSSCH can be directly sent on subsequent resources without LBT, thus reducing the risk of signal transmission failure caused by LBT failure, and reducing the extra cost caused by UE spending some time to perform LBT. Therefore, alternatively, the first UE may select consecutive multiple resources for multiple PSSCHs (whether HARQ is enabled or not may be not defined), and/or select consecutive multiple resources for multiple transmissions of one PSSCH in which HARQ is not enabled.

The advantage of selecting nonconsecutive multiple resources is that the UE can receive data or feedback signals sent by other UEs during the gap between two resources, reserve sufficient HARQ processing delay, and make the resource selection process less restrictive and more flexible. Therefore, alternatively, the first UE selects nonconsecutive multiple resources for multiple transmissions of one PSSCH in which HARQ is enabled.

In the above method, when the first UE selects the multiple resources that are consecutive in the time domain, it can also be understood that the first UE selects one resource, which includes multiple timeslots (or multiple OFDM symbols/a set of multiple OFDM symbols) that are consecutive in the time domain. In the above method, a feasible method for the first UE to select multiple resources that are consecutive in the time domain is to select a group of aggregated timeslots.

In the above method, PSSCH is used as an example. Similarly, UE may also use the above method to send the PSCCH associated with PSSCH, such as mapping the PSCCH to the PSCCH resource corresponding to the selected PSSCH resource in the same way as in the sidelink communication system in the licensed band. Therefore, the PSSCH in the above method can also be replaced by at least one of PSSCH and/or PSCCH.

In one resource determination process, the first UE selects multiple resources that are discrete or consecutive in time, further includes: selecting multiple resources among the remaining candidate resources after excluding candidate resources that may conflict with the transmissions of other UEs based on channel sensing.

In one resource determination process, the first UE selects multiple resources that are consecutive in time (m resources, m>1), including m timeslots as the time domain granularity for resource determination. Specifically, it includes determining a candidate resource with a length of m slots in the resource selection window, that is, m slot candidate resource, and includes at least one of the following:

When using periodic-based partial sensing (PBPS), PBPS occasions with a length of m slots is monitored, for example, in PBPS occasion [t_{y-k×P}_{ᵣₑₛₑᵣᵥₑ}^{SL}, t_{y-k×P}_{ᵣₑₛₑᵣᵥₑ}^{SL}+m−1] (the end position may also be t_{y-k×P}_{ᵣₑₛₑᵣᵥₑ}₊ₘ₋₁^{SL}) corresponding a candidate resource t_{y}^{SL} for timeslot [t_{y}^{SL}, t_{y}^{SL}+m−1] (the end position may also be t_{y+m-1}^{SL}), wherein Pᵣₑₛₑᵣᵥₑ is a parameter that corresponds to the service period in the resource pool, and k is a parameter indicates how many corresponding monitoring periods and which monitoring periods.

When using contiguous partial sensing (CPS), the start and end positions [n+T_{A},n+T_{B}] of the monitored CPS window are determined based on the candidate resources whose length is m slots, for example, n+T_{A} is M consecutive (logical) timeslots earlier than the start slot or end slot of the candidate resource, n+T_{B} is T_{proc,0}^{SL}+T_{proc,1}^{SL} timeslots earlier than the start slot or end slot of the candidate resource.

When determining whether to exclude candidate resources based on whether to monitor to the timeslot in which the candidate resources are located (for example, step 5 in 8.1.4 of TS 38.214), determining whether m timeslots in the candidate resources have been monitored; further, when any timeslot of the m timeslots in which the candidate resources are located is not monitored, the timeslot is excluded; further, when the number of candidate resources after excluding is lower than the threshold, candidate resources are excluded according to the number of timeslots that are not monitored. For example, candidate resources in which m timeslots are not monitored are excluded first, and then candidate resources in which m−1 timeslots are not monitored are excluded, and so on, until the number of candidate resources after excluding is higher than or equal to the threshold.

Determining whether all the m timeslots in the candidate resources will not overlap, based on whether the timeslot in which the candidate resources are located and/or the timeslot in which the transmission for the future period (future transmission) after the candidate resource is selected overlaps with the reserved resource indicated in the received Sidelink Control Information (SCI) and the reserved resource in the future period (future reserved resource) indicated in the SCI. For example, determining whether the m timeslots in the candidate resources and/or the resources corresponding to the m timeslots in the candidate resources in the future overlap with the reserved resource indicated in the received SCI and/or the future reserved resource indicated in the SCI, to determine whether to exclude the candidate resources. For example, determining at least one of followings: whether the current candidate resources and the resources indicated by SCI overlap, whether the current candidate resources and the future resources indicated by SCI overlap, whether future candidate resources and resources indicated by SCI overlap, and whether the future candidate resources and future resources indicated by SCI overlap. Further, when the number of the candidate resources after excluding is lower than the threshold, the method similar to the previous one is used to exclude the candidate resources according to the number of timeslots that will overlap. For example, when any timeslot of the m timeslots in which the candidate resources are located and/or the resources corresponding to the m timeslots in which the candidate resources are located in future overlaps with the reserved resources and/or future reserved resources indicated by the received SCI, the candidate resource is excluded; and/or, according to the number of timeslots that overlap with the reserved resources and/or future reserved resources indicated by the received SCI among the m timeslots in which the candidate resources are located and/or the number of timeslots which the corresponding resources in future overlap with the reserved resources and/or future reserved resources indicated by the received SCI among the m timeslots in which the candidate resources are located, the candidate resources are excluded.

As an example in this specification, the timeslot is used as a time unit for one transmission of PSSCH. If a time unit of other length is used for one transmission of PSSCH, such as one subframe or K OFDM symbols, the timeslot can also be replaced with the time unit of other length.

In the above method, the candidate resource with the determined time domain granularity of m timeslots is used by UE as m consecutive resources in time. The above method illustrates a method for the first UE to select m consecutive resources in time (each resource includes 1 timeslot), but it can also be understood as a method for the first UE to select a resource including m consecutive timeslots in the time domain.

Further, in one resource determination process, the first UE selects m consecutive resources in time, and/or uses m timeslots as the time domain granularity for resource determination, m is an integer greater than 1, and further including: determining the value of m according to the channel condition. Specifically, at least one of the following methods is included:

The value of m is determined according to at least one of the number of PSSCHs sent, the number of PSSCH transmissions, and the number of transmission occasions corresponding to each PSSCH transmission;

The value of m is determined according to the value of Channel Busy Ratio (CBR) and/or Channel occupancy Ratio (CR). For example, the value of m includes m1 and m2. The first UE uses m=m1, when the measured CBR is greater than or equal to the threshold value; Otherwise, the first UE uses m=m2, if the measured CBR is less than the threshold value;

After excluding the candidate resources that may conflict with the transmissions of other UEs based on channel sensing, the value of m is determined according to the number of remaining resources. For example, when the number of remaining resources is less than a specific threshold value, reduce the value of m, for example, from m to m−1, or when m includes multiple values, reduce the value from a larger value to a smaller value; and re-perform the process of the resource determination, starting from a certain step, that is, go back to the certain step, for example, starting from the step of initializing candidate resource set S_{A}.

In one channel determination process, the first UE determines multiple resources that are discrete or consecutive in time for multiple PSSCHs, and/or the first UE determines multiple resources that are consecutive in time for multiple PSSCHs, further including at least one of the following methods:

According to the parameters of each PSSCH, determining one or more resources that are discrete or consecutive in time corresponding to the PSSCH. For example, when the sizes of subchannels of multiple PSSCHs are different, UE performs sensing based resource determination based on each subchannel size. In a specific example, the UE determines 2 resources and 2 resources for the two PSSCHs respectively in one channel determination process. The frequency domain dimensions of the two PSSCHs are respectively k1 and k2 subchannels. Then the UE determines 2 resources based on k1 and 2 resources based on k2;

According to the maximum value or minimum value in multiple PSSCH parameters, determining one or more resources that are discrete or consecutive in time corresponding to multiple PSSCHs. For example, when the sizes of subchannels of multiple PSSCH are different, UE performs sensing based resource determination based on the maximum subchannel size. In a specific example, the UE determines 2 resources and 2 resources for the two PSSCH respectively in one channel determination process. The frequency domain dimensions of the two PSSCH are respectively k1 and k2 sub-channels and k2>k1. Then the UE determines a total of 4 resources based on k2 for the use of the two PSSCHs.

In the process of determining resources in the licensed band, the UE mainly selects data resources based on the purpose of avoiding conflicts as much as possible. The restrictions on the selected resources in time domain mainly include packet delay budget (PDB), which not exceeded delay parameter remaining corresponding to the service at the latest. However, in the unlicensed band, for the reliability of data transmission, UE should try to avoid reserving resources beyond the obtained COT.

Therefore, alternatively, the latest time for UE to select candidate resources does not exceed COT end position. Specifically, UE is triggered to perform the process of the resource determination in slot n, and selects candidate resources in the time interval [n+T₁,n+T₂]. Based on the minimum value T₂ₘᵢₙ of T₂ configured by configured by high-level, the determined T₂ value is: if T₂ₘᵢₙ is less than the remaining PDB and n+T₂ₘᵢₙ earlier than COT end subframe, T₂ is selected by UE on the premise that T₂ does not exceed the remaining PDB and n+T₂ₘᵢₙ earlier than COT end subframe; otherwise, T₂ is set to the smaller one of {remaining PDB, COT end position-n}.

Alternatively, when UE needs to determine N resources in the time interval [n+T₁,n+T₂], dividing the time interval into N equal parts, and selecting one resource in each part; or dividing the remaining candidate resources after excluding from the time interval into N equal parts in chronological order, and selecting one resource in each part. Alternatively, dividing into N equal parts may also be replaced by dividing into N/2 equal parts, and selecting two resources in each part; or dividing into N equal parts may also be replaced by dividing into N/3 equal parts, and selecting three resources in each part, and so on.

Since there is a fixed mapping relationship between feedback resources and data resources on the licensed band, after selecting data resources which are not conflict, the corresponding feedback resources will not conflict with other transmissions. Therefore, feedback resources are not considered in the process of determining resources on the licensed band. In the process of determining the resources on the un-licensed band, considering the effects of LBT failure, similarly, the UE should try to avoid reserving the PSSCH resources beyond the obtained COT corresponding to PSFCH.

Therefore, in the process of the resource determination, the UE may determine whether to exclude candidate resources based on whether to monitor to the timeslot in which the candidate resources are located, and alternatively, exclude the candidate resources when the PSFCH resource corresponding to a candidate resource is outside the COT (for example, after the end subframe), based on whether the timeslot in which the candidate resources are located and/or the timeslot in which the transmission for the future period after the candidate resource is selected overlaps with the reserved resource indicated in the SCI and the reserved resource in the future period indicated in the SCI. Alternatively, based on the transmission priority corresponding to the candidate resource, determining whether to exclude the candidate resource based on PSFCH inside/outside of the COT. For example, if the transmission priority falls within a specific threshold value range, the candidate resource is excluded when the PSFCH resource corresponding to a candidate resource is outside the COT (for example, after the end subframe).

In the sidelink communication system, the resources determined by the first UE in the process of the resource determination can be used not only for the sidelink transmission of the first UE itself, but also can be used for the sidelink transmission of the second UE. This mechanism is usually called as inter-UE coordination (IUC). The first UE determines the preferred or non preferred resources, and transmits the information of the resources to the second UE. Based on this information, the second UE can determine the resources for sending data to the first UE more accurately.

In the unlicensed band, the first UE needs to initialize one COT before it can perform sidelink transmission. The initialized COT can also be shared with at least one second UE for sidelink transmission of the second UE. In COT, when the transmission resource used by the first UE and the transmission resource used by the second UE are nonconsecutive in the time domain, LBT detection is required for both of them, and the transmission can be performed after the successful detection. In addition, LBT detection with larger length is required when the interval is longer, which has a higher probability of LBT failure. Therefore, to reduce the negative impact of LBT failure on transmission, a feasible method is that the first UE reasonably selects consecutive or nonconsecutive transmission resources, and shares all or some of the resources to the second UE for use through IUC information. When the resources used by the first UE and the resources used by the second UE are consecutive in the time domain, the second UE can transmit on the resource only by performing a very short LBT. If the first UE sends some signals to occupy the channel on the guard symbol between resources, the second UE may not need to perform LBT, and will not lose the COT, and can always transmit on the resource.

In the process of the resource determination, the first UE selects multiple resources and indicates the multiple resources or a subset of the multiple resources to at least one second UE through IUC information. Similar to the current IUC, the first UE determines the preferred and/or non-preferred resources and indicates the resources to the second UE. This process can also be understood as that the first UE selects (preferred and/or non-preferred) resources for the second UE. In this method, the multiple resources selected by the first UE in the process of the resource determination may include resources selected for the first UE and/or resources selected for one or more second UEs.

Alternatively, when the multiple resources selected by the first UE include resources selected for the second UE, the first UE determines a resource selection window based on the time range of resource selection provided by the second UE.

Alternatively, when the multiple resources selected by the first UE include resources selected for the second UE, at least one of the following methods is used in the process of the resource determination:

When the first UE does not expect to receive the transmission of the second UE on the resource, the selected second resource set and the first resource set may overlap or not overlap in the time domain, wherein the first resource set is the resource selected for the first UE itself, and the second resource set is the resource selected for the second UE;

When the first UE expects to receive the transmission of the second UE on the resource, the selected second resource set and the first resource set may not overlap in the time domain, where the first resource set is the resource selected for the first UE itself, and the second resource set is the resource selected for the second UE.

Alternatively, in the process of the resource determination, the first UE selects the multiple resources and indicates the multiple resources or a subset of the multiple resources to at least one second UE through IUC information, further including: selecting the multiple resources that are consecutive in time domain. The advantage of this method is that by properly processing the gap between two consecutive resources (for example, transmitting the noise signal used to occupy the channel on the AGC symbol and guard symbol), the first UE and the second UE only need to perform LBT on the earliest resource when transmitting the sidelink signal on this resource, and do not need to perform LBT on other subsequent resources. In addition, this method reduces fragmentation in the resource pool by selecting consecutive resources, thus making it easier for other UEs that need to select resources consecutively to find available consecutive resources.

In the process of the resource determination, the first UE usually determines the reserved resources based on the characteristics of the sidelink service. For example, since the sidelink SCI can indicate resources within a maximum of 32 timeslots, the first UE may reserve multiple resources with a span of no more than 32 timeslots; for example, for periodic sidelink services, when the first UE reserves resources on timeslots t1, t2, and t3, it can also reserve resources on timeslots t1+W, t2+W, and t3+W for the next period, and W is the length of the service period. Since the length of COT is limited, when transmitting periodic services on an unlicensed band, it may occur that the resources reserved by the first UE for the next period are outside the current COT. Since the UE is difficult to predict whether and when it will be able to obtain a new COT after the current COT ends, and it needs to perform a longer LBT to obtain a new COT, resources other than the current COT reserved by the first UE have a higher risk of being unable to transmit. To solve this problem, this specification proposes some possible enhancement methods.

In the process of the resource determination, if the multiple resources selected by the first UE include resources that are not in the current COT, the first UE uses at least one of the following methods:

Selecting multiple transmission occasions for each resource not in the current COT. The location of the transmission occasion, including the mapping relationship between the location of the transmission occasion and the location of the resource not in the current COT, can be (pre) defined or (pre) configured. For example, if the resource not in the current COT is located in timeslot t, then the first UE reserves timeslots t, t+1, t+2, . . . t+p as multiple transmission occasions of the resource, where the value of p is (pre) defined or (pre) configured, and can be indicated by the first UE in the SCI, so that other UEs receiving the SCI know the location of the multiple transmission occasions;

The time domain range without COT is not calculated for the offset. Here, the offset may represent the time domain offset between the resources used for two transmissions, such as the time domain offset between two transmissions in two adjacent periods, the time domain offset between two transmissions/retransmissions in the same period, and the time domain offset between PSSCH and PSFCH. For example, the current COT obtained by the first UE includes timeslots [10, 20]. The UE reserves resources on timeslot 15 and resources on 15+W=35, wherein W=20 is the period length. The next COT obtained by the first UE includes timeslots [41,60]. The timeslot range 21-40 is not included in the calculation of offset W since the COT cannot be occupied, so the timeslot of the next reserved resource is 15+W+20 (corresponding to 20 timeslots of 21−40)=55. This method is mainly applicable to the scenario where a group of UEs within the sensing range all obtain the same COT, for example, the scenario where the first UE obtains COT and shares it with all other UEs, and all other UEs will similarly share it after obtaining COT;

The reserved resources are calculated in a way that is not based on COT. If the first UE at the reserved resource location fails to obtain COT or fails to pass LBT detection, the transmission on the reserved resources is dropped.

In an unlicensed band, LBT is performed in a specific bandwidth. For example, each 20 MHz bandwidth is one LBT band. Different LBT bands perform LBT independently, and the LBT detection results are also independent of each other. Therefore, in the case of failure to transmit due to LBT failure in the same COT and failure to transmit due to LBT failure in resource reservation across COT, it can also be considered to reduce the impact of dropping transmission by monitoring in multiple LBT bands and selecting available LBT bands.

Alternatively, in the process of the resource determination, the first UE determines one or more resources for transmission of the first UE and/or the second UE within the current LBT band (alternatively, based on sensing). Alternatively, in the process of the resource determination, the first UE determines one or more resources for transmission of the first UE and/or the second UE in other LBT bands (alternatively, based on sensing, the first UE needs to monitor to other LBT bands accordingly).

The first UE indicates the selected resource as reservation in the SCI, including indicating the resource in the current LBT band and/or indicating the resource in other LBT bands. Specifically, it is indicated by at least one of the following ways:

Multiple independent domains are used to indicate the resources in each LBT band, respectively. In this method, the relative positions of resources in each LBT band can be the same or different;

A specific domain is used to indicate which resources in LBT band are reserved, and the same domain is used to indicate the location of the resources in the LBT band. In this method, the relative positions of resources in each LBT band are the same;

The (pre)configured/(pre)defined mapping method is used to determine which resources in the LBT band are reserved, without explicit indication, and to explicitly indicate the location of the reserved resources in the LBT band. Specifically, it explicitly indicates in the LBT band in which the SCI is located, the location of the reserved resources in the LBT band in which the SCI is located. In this method, the relative positions of resources in each LBT band are the same.

Alternatively, when the first UE reserves resources in multiple LBT bands in one timeslot, the UE can send the same PSSCH in the multiple LBT bands, such as the PSSCH corresponding to the same TB, or send different PSSCHs, such as different PSSCHs corresponding to different TBs. Alternatively, when the first UE reserves resources in multiple LBT bands in one timeslot, the UE can select a band that has passed LBT detection for sending PSSCH, and may not send PSSCH in other LBT bands, that is, may not actually use the reserved resources in other LBT bands. Alternatively, UE selects a band with the lowest CBR that has passed LBT detection for sending PSSCH.

In the unlicensed band, based on different scenarios and policy restrictions, two types of channel access processes are defined in the NR system: Type 1 channel access process and Type 2 channel access process, which have different channel monitoring duration and steps. Type 1 channel access process can be used for any transmission, including initialization of COT; Type 2 channel access process is further divided into 2A, 2B and 2C. Determining actual type to be used based on whether the current transmission is short control signaling and the length of the interval between the current transmission and the previous transmission.

The above type of channel access process may also be used in a sidelink communication system on an unlicensed band. UE needs to determine the type of channel access process to be used according to specific conditions.

Alternatively, when the sidelink communication system operates on an unlicensed band, the UE needs to perform a channel access process to access the channel on which the sidelink transmission is performed. Alternatively, the UE determines the type of channel access process to be used for the sidelink transmission according to at least one of the following conditions:

Type of signal/channel of the sidelink transmission; further, determining the type of channel access process to be used based on whether the sidelink transmission is PSCCH and/or PSSCH, or PSFCH, or S-SSB, or Positioning Reference Signal (PRS);

The sidelink transmission is scheduled by authorization or dynamic authorization from the configuration of the base station; for example, the UE uses Type 1 channel access process for the sidelink transmission of the configured authorization scheduling, and further determines to use Type 1 or 2A/2B/2C channel access process for the sidelink transmission of the dynamic authorization scheduling according to other conditions;

Whether the sidelink transmission is on the periodically reserved resources and/or on the dynamically reserved resources; for example, the sidelink control information SCI can indicate up to three resources whose time domain positions is in 32 timeslots, which is considered as a dynamically reserved resource; the time domain locations of up to three resources is marked as n1, n2, and n3. The resources in n1+W, n2+W, and n3+W of time domain locations may also be reserved by SCI, W is the value of the service period configured in the resource pool, these resources are considered to be resources that are periodically reserved; Type 1 channel access process is used for the sidelink transmission on the periodically reserved resources, and Type 1 or 2A/2B/2C channel access process is further determined to be used for the sidelink transmission on the dynamically reserved resources according to other conditions;

When the sidelink transmission corresponds to the received signaling, the channel access process information is indicated in the signaling, the information further includes the type of channel access process; further, the received signaling includes at least one kind of the inter-DCI, inter-SCI and inter-UE coordination information; for example, the sidelink transmission scheduled by the sidelink authorization (configured authorization and/or dynamic authorization) may be considered as the sidelink transmission corresponding to the received DCI, and the type of channel access process indicated in the DCI used by the sidelink authorization is used for the sidelink transmission; for another example, the PSFCH transmission may be considered as the sidelink transmission of the SCI associated with the corresponding received data, and the type of channel access process indicated in the SCI associated with the corresponding data is used for the PSFCH transmission; for another example, if the sidelink transmission is based on the received inter-UE coordination information (for example, the inter-UE coordination information is used in the process of the resource determination for the sidelink transmission), the type of channel access process indicated in the inter-UE coordination information is used for the sidelink transmission;

When the sidelink transmission is sent in the shared COT, the type of channel access process used by the sidelink transmission is the type of channel access process used by the node (UE and/or base station) that shares and/or initializes the COT, and/or the type of channel access process indicated by the node that shares and/or initializes the COT in signaling (such as SCI or and/or MAC CE and/or inter-UE coordination information);

Whether sidelink transmission corresponds to short control signaling;

The length of the interval between the sidelink transmission and the previous sidelink transmission.

In the NR system on the unlicensed band, considering the reliability of data services, the method of adjusting the size of the content window based on the uplink and/or downlink HARQ-ACK feedback is used. In this method, the UE or the base station determines whether the contention window value CWp needs to be increased based on whether the data sent or received includes at least one ACK (for CBG based feedback, whether at least 10% ACK is included).

The above type of channel access process may also be used in a sidelink communication system on an unlicensed band. UE needs to adjust the size of contention window according to the feedback of sidelink HARQ-ACK. However, considering the more complex situations such as NACK-only on the sidelink and multiple UE feedback ACKs in multicast, the method in the NR system needs to be improved.

Alternatively, if the UE performs sidelink transmission and the sidelink transmission is enabled with HARQ-ACK; and/or, if the UE performs sidelink reception and the received sidelink transmission is enabled with HARQ-ACK, the UE adjusts the size of the contention window based on the channel access priority according to whether the HARQ-ACK feedback is available (whether the HARQ-ACK feedback is generated and/or sent, whether the HARQ-ACK feedback is received) and whether the HARQ-ACK feedback is ACK.

Alternatively, HARQ-ACK feedback in the following cases may be used as ACK:

The sidelink transmission is unicast, and the HARQ-ACK feedback corresponding to the sidelink transmission is received/sent, and the HARQ-ACK feedback is ACK;

The sidelink transmission is groupcast, and the HARQ-ACK mode is ACK or NACK, and the HARQ-ACK feedback corresponding to the sidelink transmission is sent, and the HARQ-ACK feedback is ACK;

The sidelink transmission is groupcast, and the HARQ-ACK mode is ACK or NACK, and the HARQ-ACK feedback corresponding to the sidelink transmission is received, and the received HARQ-ACK feedback is judged to be ACK according to the method of receiving HARQ-ACK in PSFCH in NR SL on the licensed band;

The sidelink transmission is groupcast, and the HARQ-ACK mode is only NACK, and the HARQ-ACK feedback corresponding to the sidelink transmission is not sent;

The sidelink transmission is groupcast, and the HARQ-ACK mode is only NACK, and the NACK feedback corresponding to the sidelink transmission is not detected, or the received HARQ-ACK feedback is judged as ACK according to the method of receiving HARQ-ACK in PSFCH in NR SL on the licensed band.

HARQ-ACK that does not meet at least one of the above conditions can be regarded as NACK, or otherwise described below.

Alternatively, for the sidelink transmission without HARQ-ACK feedback enabled, including multicast transmission and sidelink transmission in which the HARQ feedback enable/disable indication field in the SCI is set to disable, at least one of the following methods is used to determine whether to adjust the size of the contention window:

Determining whether to adjust the size of the contention window according to whether the retransmission of the sidelink transmission is still required; for example, if it is required to retransmit the sidelink transmission, it should be processed according to the condition that HARQ-ACK feedback is not ACK; otherwise, if it is not required to retransmit the sidelink transmission, it should be processed according to the condition that HARQ-ACK feedback is ACK;

Determining whether to adjust the size of the contention window based on the number of retransmissions of the sidelink transmission that need to be performed; for example, when the number of retransmissions falls within a predetermined threshold range, the size of the contention window is not adjusted, otherwise it is adjusted; For another example, when the number of retransmissions falls within different threshold ranges, different contention window sizes are used, or contention window sizes of different ranges are increased.

Alternatively, for the sidelink transmission without HARQ-ACK feedback enabled, the size of the contention window may also be adjusted based on the priority of the service (which may be determined by the value indicated in the priority field in the SCI) and/or the channel access priority. For example, for the above method based on whether the retransmission of the sidelink transmission is required and/or the number of retransmissions of the sidelink transmission is required, only the size of the contention window corresponding to the partial service priority and/or channel access priority is adjusted.

In the above method, HARQ-ACK mode of unicast/multicast/broadcast and multicast can be determined according to the cast type indicator field in SCI of the sidelink transmission.

In addition to adjusting the size of the contention window based on the status of HARQ-ACK feedback, UE may also adjust the size of the contention window based on the busy degree of the channel. This is because the busy degree of the channel usually affects the performance of the sidelink communication at the system level. Generally, the higher busy of the channel, the worse the reliability of the sidelink communication, and the greater the probability of receiving NACK; vice versa. Therefore, the UE can alternatively adjust the size of the contention window based on the channel busy ratio (CBR), including at least one of the following methods:

For the sidelink transmission without HARQ-ACK feedback enabled, including multicast transmission and the sidelink transmission in which the HARQ feedback enable/disable indicator field in the SCI is set as disabled, determining whether to adjust the size of the contention window according to whether the CBR of the resource pool in which the sidelink transmission is located falls within the predetermined threshold range;

For the sidelink transmission without HARQ-ACK feedback enabled, including multicast transmission and the sidelink transmission in which the HARQ feedback enable/disable indicator field in the SCI is set as disabled, when the CBR of the resource pool in which the sidelink transmission is located falls within the predetermined threshold range, determining whether to adjust the size of the contention window according to whether the retransmission of the sidelink transmission is required;

For the sidelink transmission without HARQ-ACK feedback enabled, including multicast transmission and the sidelink transmission in which the HARQ feedback enable/disable indicator field in the SCI is set as disabled, when the CBR of the resource pool in which the sidelink transmission is located falls within a predetermined threshold range, determining whether to adjust the size of the contention window based on the number of retransmissions of the sidelink transmission that is required to be performed;

For the sidelink transmission with HARQ-ACK feedback enabled, the amplitude of adjusting the size of the contention window is determined based on the CBR of the resource pool in which the sidelink transmission is located (for example, based on whether the CBR falls within a predetermined threshold range). For example, when CBR is smaller, the size of the contention window will be increased less, for example, to the next higher value; when CBR is larger, the size of contention window will be increased more, for example, to the next second higher value.

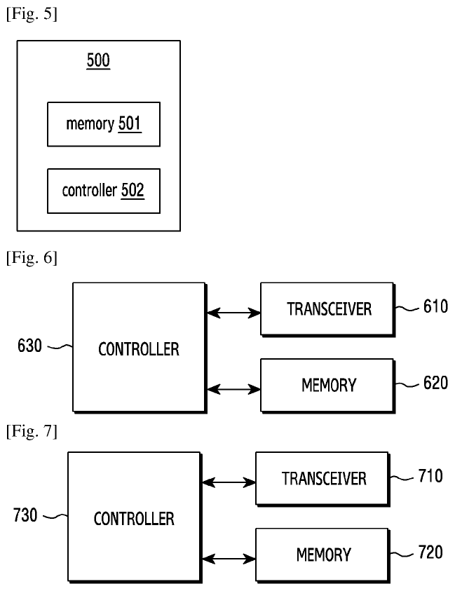

FIG. 5 shows a block diagram of an electronic device 500 according to an embodiment of the present disclosure. The electronic device includes: a memory 501 configured to store computer programs; and a controller 502 configured to read a computer program from a memory, run a computer program, and implement the method described in the present disclosure.

FIG. 6 illustrates a block diagram of a terminal (or a user equipment (UE)), according to embodiments of the present disclosure.

As shown in Figure. 6, a terminal according to an embodiment may include a transceiver 610, a memory 620, and a controller 630. The transceiver 610, the memory 620, and the controller 630 of the terminal may operate according to a communication method of the terminal described above. However, the components of the terminal are not limited thereto. For example, the terminal may include more or fewer components than those described in FIG. 6. In addition, the controller 630, the transceiver 610, and the memory 620 may be implemented as a single chip. Also, the controller 630 may include at least one processor. Furthermore, the UE of FIG. 6 corresponds to the UE of the FIG. 3A.

The transceiver 610 collectively refers to a terminal station receiver and a terminal transmitter, and may transmit/receive a signal to/from a base station or another terminal. The signal transmitted or received to or from the terminal may include control information and data. The transceiver 610 may include a RF transmitter for up-converting and amplifying a frequency of a transmitted signal, and a RF receiver for amplifying low-noise and down-converting a frequency of a received signal. However, this is only an example of the transceiver 610 and components of the transceiver 610 are not limited to the RF transmitter and the RF receiver.

Also, the transceiver 610 may receive and output, to the controller 630, a signal through a wireless channel, and transmit a signal output from the controller 630 through the wireless channel.

The memory 620 may store a program and data required for operations of the terminal. Also, the memory 620 may store control information or data included in a signal obtained by the terminal. The memory 620 may be a storage medium, such as read-only memory (ROM), random access memory (RAM), a hard disk, a CD-ROM, and a DVD, or a combination of storage media.

The controller 630 may control a series of processes such that the terminal operates as described above. For example, the controller 630 may transmit a data signal and/or a control signal to a base station, and the controller 630 may receive a data signal and/or a control signal from a base station.

FIG. 7 illustrates a block diagram of a base station, according to embodiments of the present disclosure.

As shown in Figure. 7 is, the base station of the present disclosure may include a transceiver 710, a memory 720, and a controller 730. The transceiver 710, the memory 720, and the controller 730 of the base station may operate according to a communication method of the base station described above. However, the components of the base station are not limited thereto. For example, the base station may include more or fewer components than those described in FIG. 7. In addition, the controller 730, the transceiver 710, and the memory 720 may be implemented as a single chip. Also, the controller 730 may include at least one processor. Furthermore, the base station of FIG. 7 corresponds to the gNB of the FIG. 3B.

The transceiver 710 collectively refers to a base station receiver and a base station transmitter, and may transmit/receive a signal to/from a terminal, another base station, and/or a core network function(s) (or entity(s)). The signal transmitted or received to or from the base station may include control information and data. The transceiver 710 may include a RF transmitter for up-converting and amplifying a frequency of a transmitted signal, and a RF receiver for amplifying low-noise and down-converting a frequency of a received signal. However, this is only an example of the transceiver 710 and components of the transceiver 710 are not limited to the RF transmitter and the RF receiver.

Also, the transceiver 710 may receive and output, to the controller 730, a signal through a wireless channel, and transmit a signal output from the controller 730 through the wireless channel.

The memory 720 may store a program and data required for operations of the base station. Also, the memory 720 may store control information or data included in a signal obtained by the base station. The memory 720 may be a storage medium, such as ROM, RAM, a hard disk, a CD-ROM, and a DVD, or a combination of storage media.

The controller 730 may control a series of processes such that the base station operates as described above. For example, the controller 730 may receive a data signal and/or a control signal from a terminal, and the controller 730 may transmit a data signal and/or a control signal to a terminal.

The methods according to the embodiments described in the claims or the detailed description of the present disclosure may be implemented in hardware, software, or a combination of hardware and software.

When the electrical structures and methods are implemented in software, a computer-readable recording medium having one or more programs (software modules) recorded thereon may be provided. The one or more programs recorded on the computer-readable recording medium are configured to be executable by one or more processors in an electronic device. The one or more programs include instructions to execute the methods according to the embodiments described in the claims or the detailed description of the present disclosure.

The programs (e.g., software modules or software) may be stored in random access memory (RAM), non-volatile memory including flash memory, read-only memory (ROM), electrically erasable programmable read-only memory (EEPROM), a magnetic disc storage device, compact disc-ROM (CD-ROM), a digital versatile disc (DVD), another type of optical storage device, or a magnetic cassette. Alternatively, the programs may be stored in a memory system including a combination of some or all of the above-mentioned memory devices. In addition, each memory device may be included by a plural number.

The programs may also be stored in an attachable storage device which is accessible through a communication network such as the Internet, an intranet, a local area network (LAN), a wireless LAN (WLAN), or a storage area network (SAN), or a combination thereof. The storage device may be connected through an external port to an apparatus according the embodiments of the present disclosure. Another storage device on the communication network may also be connected to the apparatus performing the embodiments of the present disclosure.

In the afore-described embodiments of the present disclosure, elements included in the present disclosure are expressed in a singular or plural form according to the embodiments. However, the singular or plural form is appropriately selected for convenience of explanation and the present disclosure is not limited thereto. As such, an element expressed in a plural form may also be configured as a single element, and an element expressed in a singular form may also be configured as plural elements.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

The term “module” may indicate a unit including hardware, software, firmware, or a combination thereof. The term “module” may interchangeably be used with other terms, for example, “logic,” “logic block,” “part,” or “circuitry”. The term “module” may indicate a minimum unit or part that performs one or more functions. The term “module” refers to a device that can be implemented mechanically or electronically. For example, the term “module” may indicate a device that includes at least one of an application specific integrated circuit (ASIC), a field programmable gate array (FPGA), or a programmable logic array (PLA) that performs certain operations that are known or will be developed in the future.

According to embodiments of the present disclosure, at least a portion of a device (e. g., a module or its function) or a method (e. g., an operation) may be implemented as instructions stored in a non-temporary computer-readable storage medium, for example, in the form of a programming circuit. When run by the processor, instructions make the processor to perform the corresponding functions. A non-temporary computer-readable storage medium may be, for example, a memory.

Non-temporary computer-readable storage medium may include hardware devices such as hard disks, floppy disks, and magnetic tapes (for example, magnetic tapes), optical media such as optical disk read-only memory (ROM) (CD-ROM) and digital versatile optical disk (DVD), magneto-optical medium such as optical disks, ROM, random access memory (RAM), flash memory, and the like. Examples of program commands may include not only machine language code, but also high-level language code that can be run by various computing devices using an interpreter. The above hardware devices may be configured to operate as one or more software modules to perform embodiments of the present disclosure, and vice versa.

A circuit or programming circuit according to various embodiments of the present disclosure may include at least one or more of the foregoing components, omit some of them, or also include other additional components. Operations performed by circuits, programming circuits, or other components according to various embodiments of the present disclosure may be performed sequentially, simultaneously, repeatedly, or heuristically. In addition, some operations may be performed in different order, or omitted, or include other additional operations.

The embodiments of the present disclosure are described to facilitate understanding of the present disclosure, but are not intended to limit the scope of the present disclosure. Therefore, the scope of the present disclosure should be interpreted to include all changes or various embodiments based on the scope of the present disclosure defined by the appended claims and their equivalents.

1. A method performed by a user equipment (UE) in a wireless communication system, the method comprising:
identifying a number of consecutive slots configured with a value larger than 1; and
identifying a candidate multi-slot resource to be applied,
wherein, in case that the consecutive slots configured with the value larger than 1 are consecutive in time, the candidate multi-slot resource is configured in the consecutive slots.

2. The method of claim 1, further comprising:
in case of performing periodic-based partial sensing (PBPS), monitoring slots associated with PBPS occasions.

3. The method of claim 1, further comprising:
performing contiguous partial sensing (CPS) based on a sensing window,
wherein the sensing window starts at M consecutive logical slots earlier than a start slot of a selected candidate slots, where M is a positive integer.

4. The method of claim 3, wherein the sensing window ends at (a first processing time+a second processing time) slots earlier than the start slot of the selected candidate slots.

5. The method of claim 3, further comprising:
excluding the candidate multi-slot resource which is not monitored, among a set of slots of a resource pool.

6. The method of claim 2, wherein the PBPS occasions are configured based on periodicity values.

7. The method of claim 1, further comprising:
identifying the value according to channel conditions.

8. The method of claim 7, wherein the identifying the value according to channel conditions includes at least one of:
identifying the value according to at least one of a number of sidelink data transmitted, a number of sidelink data transmissions, and a number of transmission occasions corresponding to each sidelink data transmission;
identifying the value according to a channel busy rate CBR and/or a channel occupation rate CR; and
identifying the value according to a number of remaining resources after excluding candidate resources conflicting with transmissions of other nodes based on a channel sensing.

9. A user equipment (UE) in a wireless communication system, the UE comprising:
a transceiver; and
a controller coupled with the transceiver and configured to:
identify a number of consecutive slots configured with a value larger than 1; and
identify a candidate multi-slot resource to be applied,
wherein, in case that the consecutive slots configured with the value larger than 1 are consecutive in time, the candidate multi-slot resource in configured is the consecutive slots.

10. The UE of claim 9, wherein the controller is further configured to:
in case of performing periodic-based partial sensing (PBPS), monitor slots associated with PBPS occasions.

11. The UE of claim 9, wherein the controller is further configured to:
perform contiguous partial sensing (CPS) based on a sensing window,
wherein the sensing window starts at M consecutive logical slots earlier than a start slot of a selected candidate slots, where M is a positive integer.

12. The UE of claim 11, wherein the sensing window ends at (a first processing time+a second processing time) slots earlier than the start slot of the selected candidate slots.

13. The UE of claim 11, wherein the controller is further configured to:
exclude the candidate multi-slot resource which is not monitored, among a set of slots of a resource pool.

14. The UE of claim 10, wherein the PBPS occasions are configured based on periodicity values.

15. The UE of claim 9, wherein the controller is further configured to:
identify the value according to channel conditions.
